(19) United States
(12) Patent Application Publication
(10) Pub. No.: US 2008/0252932 A1
(43) Pub. Date: Oct. 16, 2008

(54) Techniques to synchronize information between fidelity domains

(75) Inventor: Peter P. Baer, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/786,836

(22) Filed: Apr. 13, 2007

(51) Int. Cl. H04N 1/00

(52) U.S. Cl. 358/400

(57) ABSTRACT

Techniques to synchronize information between fidelity domains are described. A computer system may include a first application program having a low fidelity domain, and a second application program having a high fidelity domain. The second application program may include a fidelity synchronization module to synchronize modifications between a low fidelity version of a document made using the first application program and a high fidelity version of the document made using the second application program using a three-way merge. Other embodiments are described and claimed.

### BACKGROUND

A merge operation is a common editing operation for combining two or more textual documents or other types of sequences together. The documents to be merged may be, for example, different versions of software source code with modifications by different software developers, or different versions of a word-processing document edited on different machines. The documents to be merged typically contain some common parts and some parts that are different, and overlapping differences are viewed as conflicts that may require the input of a user to resolve the conflicts, such as picking the parts from the right version to be included in the final merged document.

A three-way merge operation has three sequences of elements as its inputs. Typically, the three sequences include one sequence designated as an original version and two versions that are typically derived from the original. For example, the three sequences may correspond to an original source code file, a first modified version of the source code with changes made by one developer, and a second modified version of the source code containing changes made by another developer. The three sequences may be used as input to a three-way merge algorithm to generate a “difference” log between the base and the respective branches, combine them, and apply them to the base to produce the final result. Three-way merge operations, however, may have increasing levels of complexity based upon the type of documents being merged. Consequently, there may be a substantial need for improvements in merge techniques to solve these and other problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments are generally directed to techniques for synchronizing information such as documents between fidelity domains. Some embodiments are particularly directed to techniques for synchronizing documents having varying levels of multimedia content fidelity. In one embodiment, for example, a first application program may have a low fidelity domain, while a second application program may have a high fidelity domain. The second application program may include a fidelity synchronization module to synchronize modifications between a low fidelity version of a document made using the first application program and a high fidelity version of the document made using the second application program.

In one embodiment, for example, the fidelity synchronization module may perform synchronization operations using a three-way merge technique. The fidelity synchronization module may include an import module, an export module, and a merge module. The import module may be arranged to import a first low fidelity version of the document to form a first high fidelity version of the document. The first application program may be used to modify the first low fidelity version of the document to form a second low fidelity version of the document. The second application program may be used to modify the first high fidelity version of the document to form a second high fidelity version of the document. The import module may import the second low fidelity version to form a third high fidelity version of the document. The merge module may be arranged to perform the three-way merge with the first high fidelity version, the second high fidelity version, and the third high fidelity version of the document to form a fourth high fidelity version of the document. The export module may be arranged to export the fourth high fidelity version from the high fidelity domain to the low fidelity domain to form a third low fidelity version of the document. In this manner, modifications or changes made to a low fidelity version of the document in the low fidelity domain may be synchronized with modifications or changes made to a high fidelity version of the document in the high fidelity domain, and vice-versa. Other embodiments are described and claimed.

### BRIEF DESCRIPTION OF THE DRAWINGS

FIG. 1 illustrates one embodiment of a computing system.

FIG. 2 illustrates one embodiment of a first logic diagram.

FIG. 3 illustrates one embodiment of a logic flow.

FIG. 4A illustrates one embodiment of a second logic diagram.

FIG. 4B illustrates one embodiment of a third logic diagram.

FIG. 4C illustrates one embodiment of a fourth logic diagram.

FIG. 5 illustrates one embodiment of a computing system architecture.

### DETAILED DESCRIPTION

Various embodiments may comprise one or more elements. An element may comprise any feature, characteristic, structure or operation described in connection with an embodiment. Examples of elements may include hardware elements, software elements, physical elements, or any combination thereof. Although an embodiment may be described with a limited number of elements in a certain arrangement by way of example, the embodiment may include more or less elements in alternate arrangements as desired for a given implementation. It is worthy to note that any references to “one embodiment” or “an embodiment” are not necessarily referring to the same embodiment.

Various embodiments may be directed to techniques to improve synchronization of documents modified by multiple application programs offering different levels of fidelity. The term “document” may include any set of discrete information, such as a document file, data file, object, item, template, and so forth. For example, a computing device may include a first application program to create documents with a relatively low level of fidelity, and a second application program to create documents with a relatively high level of fidelity, particularly when compared with the first application program. As used herein, the term “fidelity” may refer to the level of accuracy when reproducing information or media content from one document to another document. The information or media content may include any type of multimedia information that may be included or embedded in a document, such as text, numbers, symbols, alphanumeric symbols, pictures, graphics, images, video information, audio information, and so forth.

In some embodiments, a fidelity synchronization module may be used to synchronize documents between a low fidelity domain and a high fidelity domain. A low fidelity domain may refer to an application program having a lower level of content fidelity when compared to another application program. A high fidelity domain may refer to an application program having a higher level of content fidelity when compared to another application program. The terms “low fidelity” and “high fidelity” are therefore used in a relative sense rather than in absolute terms.

In various embodiments, a fidelity synchronization module may be arranged to synchronize modifications between a low fidelity version of a document made using the first application program and a high fidelity version of the document made using the second application program. In one embodiment, for example, the fidelity synchronization module may perform synchronization operations using a three-way merge technique.

Conventional three way merge techniques, however, are typically limited to merging documents of the same format or fidelity. As previously described, a three-way merge operation has three sequences of elements as its inputs. Typically, the three sequences include one sequence designated as an original version and two versions that are typically derived from the original. For example, the three sequences may correspond to an original document, a first modified version of the document with changes made by one operator, and a second modified version of the document containing changes made by another operator, or the same operator at different times on different devices.

Three-way merge operations, however, may have increasing levels of complexity based upon the type of documents being merged. This is particularly true when the documents are being imported and/or exported between domains with different levels of fidelity. For example, assume a document is being exported between a simple text-based word processor and a full-featured word processor allowing multimedia content. Simple import/export techniques would become more complex since modifications made using the full-featured word processor, such as insertion of a graphic, may not synchronize to a document used by the text-based word processor. This problem becomes further exacerbated when modifications are being made to a low fidelity version of the document and a high fidelity version of the document at the same time.

Various embodiments attempt to solve these and other problems. Various embodiments may be implemented to enable bi-directional synchronization operations between different fidelity levels of media content. Various embodiments may be implemented to synchronize a document that exists in various formats such that changes in either format can be replicated to the other deterministically.

Some implementations may synchronize information between different fidelity domains by keeping a base version in a high fidelity domain that is derived directly from the import of an equivalent state in a low fidelity domain for each low fidelity store that is synchronized with the high fidelity store. In this way, additional media or multimedia content for the high fidelity domain always appears as a change in the three-way merge operations to produce an operator-visible version in the high fidelity domain format. This may reduce programming requirements for the synchronization operations. To accomplish this, the fidelity synchronization module should support “round-trip” import and export operations, as follows: (1) where an import followed by an export should produce substantially the same low-fidelity version; (2) an export followed by an import should produce substantially the same high-fidelity revision minus any high fidelity content that could not be represented in the low fidelity store; and (3) the import and export operations both need to be relatively “stable” where small changes to the input should result in proportionally small changes to the output.

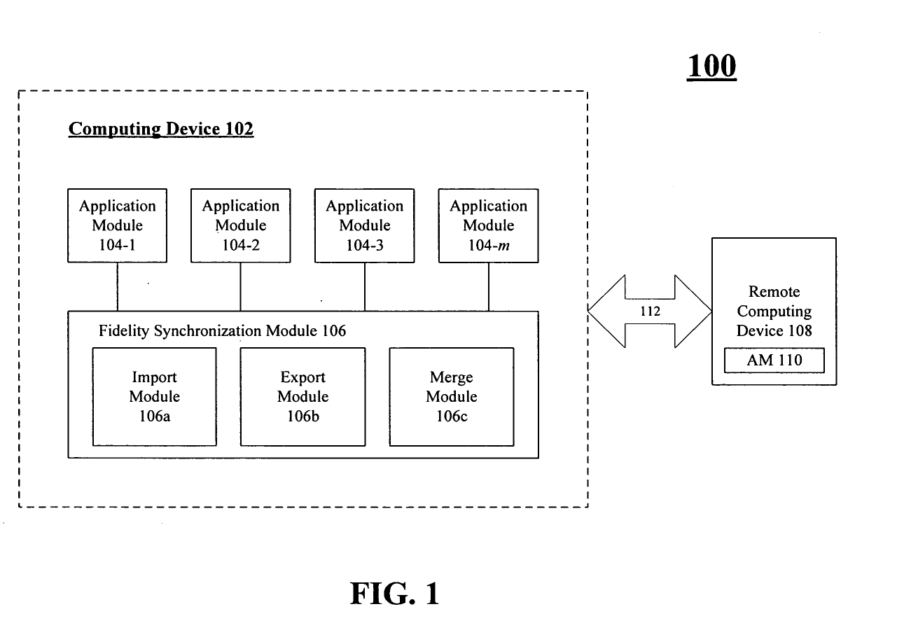

FIG. 1 illustrates a block diagram of a computing system 100. The computing system 100 may represent any computing system, architecture, or infrastructure arranged to create, store, process, communicate, synchronize, and otherwise manage documents or information for an electronic system or collection of electronic systems. As shown in FIG. 1, one embodiment of the computing system 100 may include a computing device 102 coupled to one or more remote computing devices 108. Computing device 102 may comprise two or more application modules 104-1-m coupled to a fidelity synchronization module 106. The fidelity synchronization module 106 may further comprise an import module 106a, an export module 106b, and a merge module 106c. Remote computing device 108 may include an application module 110. In some cases, the modules 104, 110 may be the same or similar modules. In other cases, the modules 104, 110 may be arranged as client-server applications or peer-to-peer applications as desired for a given implementation. Additional details for one embodiment of computing device 102 and remote computing device 108 may be further illustrated and described with reference to FIG. 9.

As used herein the term “module” may include any structure implemented using hardware elements, software elements, or a combination of hardware and software elements. In one embodiment, for example, the modules described herein are typically implemented as software elements stored in memory and executed by a processor to perform certain defined operations. It may be appreciated that the defined operations may be implemented using more or less modules as desired for a given implementation. It may be further appreciated that the defined operations may be implemented using hardware elements based on various design and performance constraints. The embodiments are not limited in this context.

In various embodiments, the computing system 100 may be used to create, store, process, communicate, synchronize, and otherwise manage documents or information between application programs 104-1-m and/or 110. With respect to computing device 102 and/or remote computing device 108, the fidelity synchronization module 106, the application programs 104-1-m and 110, and/or any shared or associated information (e.g., media context, data structures, data schemas, data files, and so forth) may be stored and accessed via any number of memory units, storage media, machine readable media, or computer-readable media implemented for a given computing device. Computing device 102 and remote computing device 108 may represent any type of electronic device having the appropriate hardware, software or combination hardware and software arranged to execute the operations of the application modules 104-1-m, the fidelity synchronization module 106, and/or the application module 110.

In various embodiments, the fidelity synchronization module 106 may be used to synchronize documents between a low fidelity domain and a high fidelity domain. In one embodiment, for example, the fidelity synchronization module 106 may be implemented as part of the higher fidelity application program, such as the application program 104-2, for example. In this case, the low fidelity domain may not need any modifications to perform merge or synchronization operations. Although some embodiments may describe the fidelity synchronization module 106 as being implemented with the application program 104-2, it may be appreciated that the fidelity synchronization module 106 may be implemented in other components, devices or systems of the computing devices 102 and/or 108, with the appropriate modifications. In one embodiment, for example, the fidelity synchronization module 106 may be implemented as part of the lower fidelity application program, such as the application program 104-1. In one embodiment, for example, the fidelity synchronization module 106 may be implemented as part of the high and low fidelity application programs in combination. In one embodiment, for example, the fidelity synchronization module 106 may be implemented in another component or system of the computing system 100, such as a component or system of the computing devices 102 or 108. The embodiments are not limited in this context.

More particularly, the fidelity synchronization module 106 may be used to synchronize documents between a first application program offering a first level of content fidelity, and a second application program offering a second level of content fidelity. For example, assume that the application program 104-1 is implemented as a simple web service offering a graphic user interface (GUI) with a text-only box, or a text-based word processing program, that can only display media content in the form of alphanumeric symbols. Further, assume that the second application program 104-2 may comprise an application program that can display multimedia content, such as alphanumeric symbols and graphics. In one embodiment, for example, the second application program 104-2 may comprise an application program from the MICROSOFT® OFFICE suite of application programs, made by Microsoft Corporation, Redmond, Wash. By way of example and not limitation, some embodiments may be described with the second application program implemented as a MICROSOFT OFFICE ONENOTE® application program, usually referred to as MICROSOFT ONENOTE. The MICROSOFT ONENOTE application program is a tool for taking notes, information gathering, and multi-user collaboration. The notes may be categorized together into notebooks. Although some embodiments may be described with these two application programs by way of example only, it may be appreciated that any application programs may be used and still fall within the scope of the embodiments. For example, the second application program 104-2 may be implemented as a MICROSOFT OFFICE WORD application program, usually referred to as MICROSOFT WORD. The MICROSOFT WORD application program is a full-feature word processing application program that can be used to create, modify and manage documents having multimedia content. The embodiments are not limited in this context.

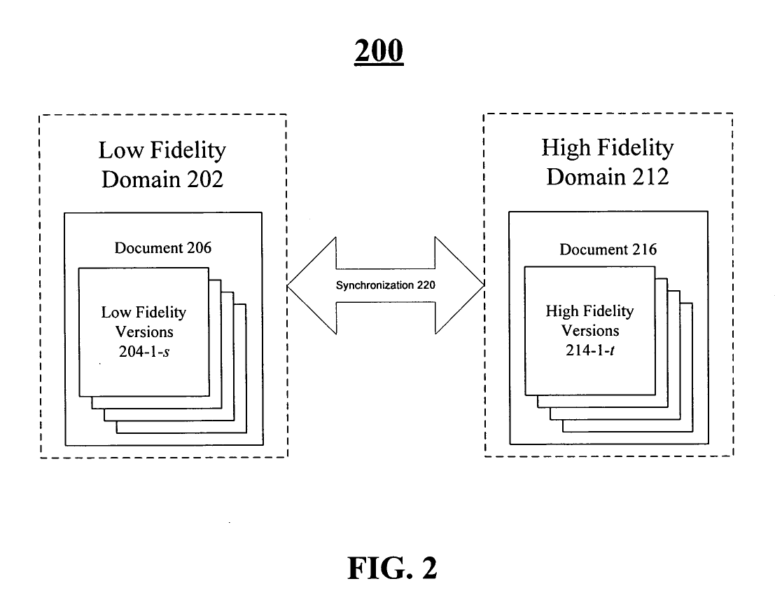

FIG. 2 illustrates a logic diagram 200. The logic diagram 200 illustrates a low fidelity domain 202 and a high fidelity domain 212. The low fidelity domain 202 may represent an application program providing a lower level of content fidelity for a document, such as the application program 104-1. The low fidelity domain 202 may include, for example, one or more low fidelity versions 204-1-s of a document 206. The document 206 may represent a document having a format for the text-based word processor implemented for the application program 104-1. The high fidelity domain 212 may represent an application program providing a higher level of content fidelity for a document, such as the application program 104-2. The high fidelity domain 212 may include, for example, one or more high fidelity versions 214-1-t of a document 216. The document 216 may represent a document having a format for a MICROSOFT ONENOTE application program 104-2. The documents 206, 216 are generally intended to have similar media content, and are typically limited only by the fidelity capabilities provided by the respective application programs 104-1, 104-2, as represented by the respective fidelity versions 204-1-s and 214-1-t.

In various embodiments, the fidelity synchronization module 106 may perform synchronization operations between the low fidelity domain 202 and the high fidelity domain 212. This may be accomplished using synchronization circuit 220. The synchronization circuit 220 may be representative of, for example, the operations performed by the fidelity synchronization module 106.

In various implementations, the synchronization circuit 220 and/or fidelity synchronization module 106 may be arranged to synchronize modifications between a low fidelity version 204-1-s of the document 206 made using the first application program 104-1 and a high fidelity version 214-1-t of the same or similar document 216 made using the second application program 104-2. In one embodiment, for example, the fidelity synchronization module 106 may perform synchronization operations between domains 202, 212 using various modules, such as an import module 106a, an export module 106b, and a merge module 106c.

In general operation, for example, the import module 106a may be arranged to import a first low fidelity version 204-1 of the document 206 to form a first high fidelity version 214-1 of the document 216 via the synchronization circuit 220. Assume an operator uses the first application program 104-1 to modify the first low fidelity version 204-1 of the document 206 to form a second low fidelity version 204-2 of the document 206. Assume the same or different operator uses the second application program 104-2 to modify the first high fidelity version 214-1 of the document 216 to form a second high fidelity version 214-2 of the document 216. In some cases, for example, assume the same or different operator uses the second application program 104-2 to modify the first high fidelity version 214-1 of the document 216 to form the second high fidelity version 214-2 of the document 216, with the modification to include media or multimedia content that cannot be represented in the low fidelity domain 202 of the first application program 104-1. Stated another way, assume the modification includes media or multimedia content that can only be represented in the high fidelity domain 212 of the second application program 104-2. In such cases, the synchronization operations performed by the fidelity synchronization module 106 potentially become more complex.

At this point there are multiple changes to multiple versions of a document in different domains. To merge or reconcile the multiple versions of a document in different domains into a single version, the fidelity synchronization module 106 may perform a three-way merge operation using the merge module 106c. This may be accomplished, for example, since there is a common ancestor for the second low fidelity version 204-2 and the second high fidelity version 214-2, namely, the first high fidelity version 214-1. It is worthy to note that the first high fidelity version 214-1 is substantially the same version as imported from the first low fidelity version 204-1. Consequently, the modifications to the first high fidelity version 214-1 to form the second high fidelity version 214-2 are made to a copy of the first high fidelity version 214-1 to leave the first high fidelity version 214-1 uncorrupted and in the same state as when imported from the first low fidelity version 204-1.

In various embodiments, the merge module 106c may perform a three-way merge operation to produce a merged output. A three-way merge operation has three sequences of elements as its inputs. Typically, the three sequences include one sequence designated as an original version and two versions that are typically derived from the original. The three sequences may be used as input to a three-way merge algorithm to generate a “difference” log between the base and the respective branches, combine them, and apply them to the base to produce the final result. By way of example, a three-way merge is performed after an automated difference analysis between a file “A” and a file “B” while also considering the origin, or parent “C”, of both files. Typically, the parent C is the same for both files A, B. This type of merge is generally only available through the use of supporting revision control systems where such a parent would normally exist or be preserved. Accordingly, the merge module 106c may examine the differences and patterns appearing in the changes between files A, B as well as the parent C, build a relationship model to generate a merge of files A, B and the parent C, to produce a new revision “D.”

To perform three-way merge operations, the import module 106a may import the second low fidelity version 204-2 to form a third high fidelity version 214-3 of the document 216 via the synchronization circuit 220. The merge module 106c may be arranged to perform the three-way merge operation using the first (uncorrupted) high fidelity version 214-1, the second high fidelity version 214-2, and the third high fidelity version 214-3 of the document 216 to form a fourth high fidelity version 214-4 of the document 216. More particularly, the merge module 106c may perform the three-way merge to form the fourth high fidelity version 214-4 of the document 216 having modifications from both the second high fidelity version 214-2 and the third high fidelity version 214-3. This may be accomplished, for example, using the first high fidelity version 214-1 as a common ancestor, or the parent C in the previous example.

After forming the fourth high fidelity version 214-4 with the modifications to high fidelity versions 214-2, 214-3, the synchronization circuit 220 may be used to synchronize the fourth high fidelity version 214-4 with a corresponding version for the low fidelity domain 202. Consequently, the export module 106b may be arranged to export the fourth high fidelity version 214-4 from the high fidelity domain 212 to the low fidelity domain 202 to form a third low fidelity version 204-3 of the document 206. Accordingly, the third low fidelity version 204-3 of the document will include modifications from both the second high fidelity version 214-2 and the third high fidelity version 214-3, absent any high fidelity media content that could not be represented by the low fidelity domain 202. In this manner, modifications or changes made to a low fidelity version 204-1-s of the document in the low fidelity domain 202 may be synchronized with modifications or changes made to a high fidelity version 214-1-t of the document 216 in the high fidelity domain 212, and vice-versa.

Operations for the computing system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the computing system 100 or alternative elements as desired for a given set of design and performance constraints.

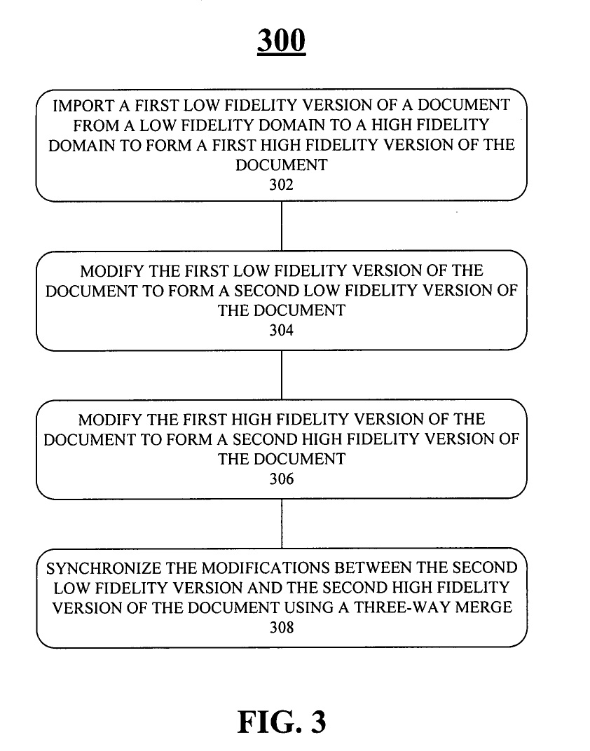

FIG. 3 illustrates a logic flow 300. The logic flow 300 may be representative of the operations executed by one or more embodiments described herein. As shown in FIG. 3, the logic flow 300 may import a first low fidelity version of a document from a low fidelity domain to a high fidelity domain to form a first high fidelity version of the document at block 302. The logic flow 300 may modify the first low fidelity version of the document to form a second low fidelity version of the document at block 304. The logic flow 300 may modify the first high fidelity version of the document to form a second high fidelity version of the document at block 306. For example, the first high fidelity version of the document may be modified to include content that cannot be represented in the low fidelity domain, or that can only be represented in the high fidelity domain, to form the second high fidelity version of the document. The logic flow 300 may synchronize the modifications between the second low fidelity version and the second high fidelity version of the document using a three-way merge at block 308. The embodiments are not limited in this context.

In one embodiment, for example, the logic flow 300 may synchronize the modifications between the second low fidelity version and the second high fidelity version of the document using a three-way merge. For example, the second low fidelity version may be imported from the low fidelity domain to the high fidelity domain to form a third high fidelity version of the document. The three-way merge may be performed with the first high fidelity version, the second high fidelity version, and the third high fidelity version of the document to form a fourth high fidelity version of the document. The fourth high fidelity version of the document may include modifications from both the second high fidelity version and the third high fidelity version. To synchronize the fourth high fidelity version with the low fidelity domain, the fourth high fidelity version may be exported from the high fidelity domain to the low fidelity domain to form a third low fidelity version of the document. The third low fidelity version of the document may include modifications from both the second high fidelity version and the third high fidelity version.

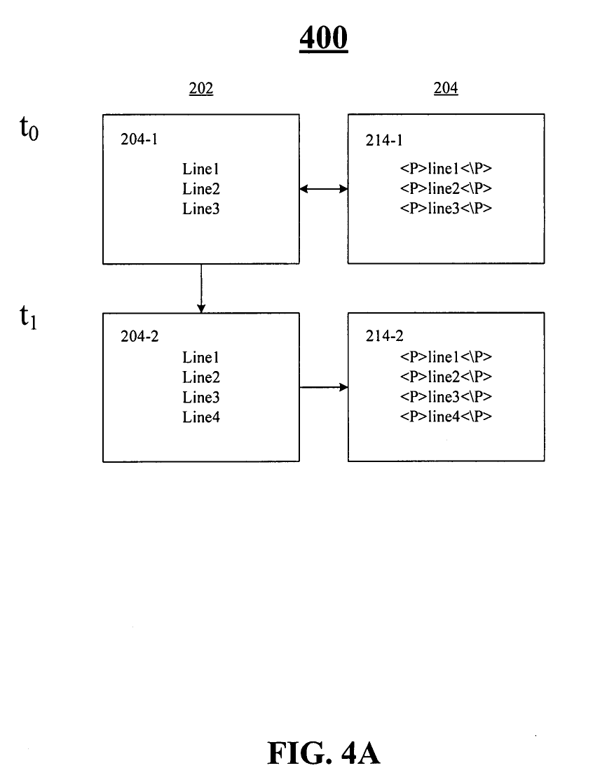

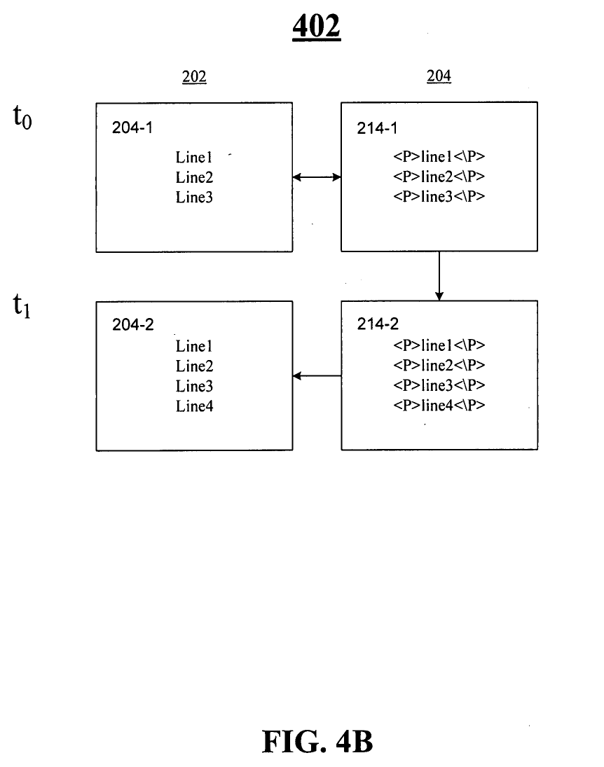

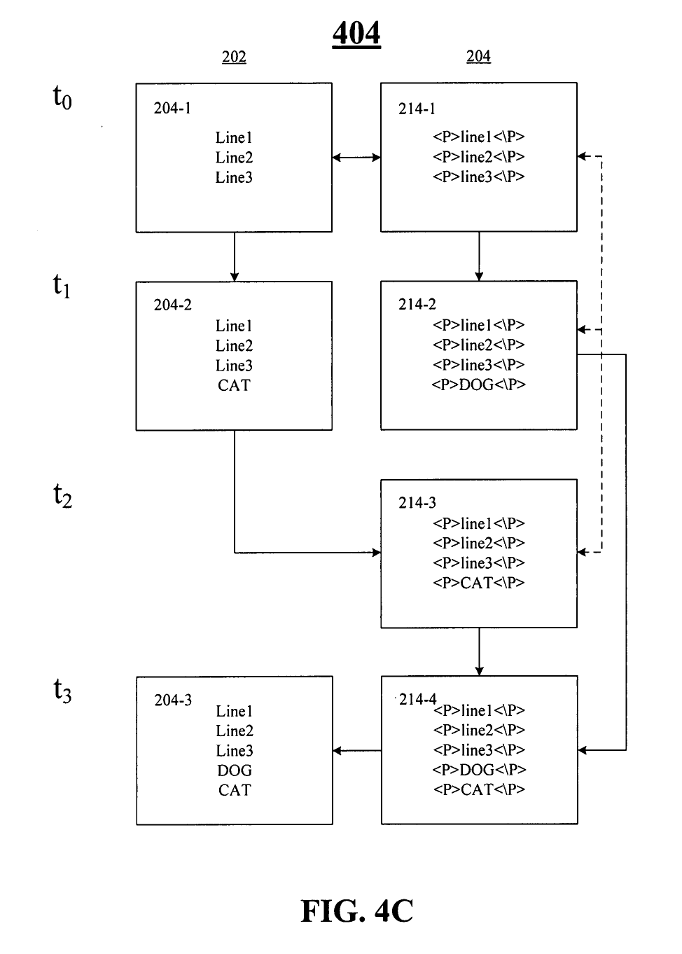

The embodiments described with respect to the computing system 100, the logic diagram 200, or the logic flow 300, may be further described by way of example with reference to FIGS. 4-8. To illustrate the three-way merge algorithm of an embodiment, consider a document that exists in two formats. The first format may comprise a rich or high fidelity version (214-1) of the document that supports 3-way merge. The second format may comprise a limited or low fidelity version (204-1) of the document (e.g., plain text). Thus at the beginning (t₀) there exists two copies of the same document 214-1 and 204-1, where 204-1 is a lower fidelity version of 214-1, and they are currently in synchronization. The three-way merge algorithm for synchronizing changes between these different formats can be broken down into three cases, with the third case being the most complicated case.

FIG. 4A illustrates a logic diagram 400. The logic diagram 400 provides an example of a low fidelity change occurring in the low fidelity domain 202. The logic diagram 400 may illustrate how a modified low fidelity version of 204-1 resulting in a low fidelity version 204-2 can be merged into the high fidelity domain 212. As shown in FIG. 4A, when synchronizing or merging the low fidelity version 204-2 into the high fidelity domain 212, it may be recognized that low fidelity version 204-2 has a base or parent in the low fidelity version 204-1 that is synchronized with the high fidelity version 214-1 in the high fidelity domain 212. Since the low fidelity version 204-2 already contains all the changes of the low fidelity version 204-1, and the low fidelity version 204-1 contains all the changes in the high fidelity version 214-1, it can be inferred that the low fidelity version 204-2 already contains all the changes in the high fidelity version 214-1 (absent domain limitations). Thus, the import module 106a can perform a straight import of the low fidelity version 204-2 into the high fidelity domain 212 to form a high fidelity version 214-2 without performing any merge operations via the merge module 106c.

FIG. 4B illustrates the logic diagram 402. The logic diagram 402 provides an example of a high fidelity change occurring in the high fidelity domain 212. The logic diagram 402 may illustrate how a modified high fidelity version of 214-1 resulting in a high fidelity version 214-2 can be merged into the low fidelity domain 202. As shown in FIG. 4B, when synchronizing or merging the high fidelity version 214-2 into the low fidelity domain 202, it may be recognized that high fidelity version 214-2 has a base or parent in the high fidelity version 214-1 that is synchronized with the low fidelity version 204-1 in the low fidelity domain 202. Since the high fidelity version 214-2 already contains all the changes of the high fidelity version 214-1, and the high fidelity version 214-1 contains all the changes in the low fidelity version 204-1, it can be inferred that the high fidelity version 214-2 already contains all the changes in the low fidelity version 204-1. Thus, the import module 106a can perform a straight import of the high fidelity version 214-2 into the low fidelity domain 202 to form a low fidelity version 204-2 without performing any merge operations via the merge module 106c.

FIG. 4C illustrates the logic diagram 404. The logic diagram 404 provides an example of a low fidelity change occurring in the low fidelity domain 202 and a high fidelity change occurring in the high fidelity domain 204. The logic diagram 404 may illustrate how modifications to both versions 204-1, 214-2 of the document resulting in respective versions 204-2, 214-2 can be merged together. In this case, it may not be possible to perform a straight import from one fidelity format to another without losing changes. To merge the versions 204-2, 214-2, the version 204-2 can be imported into the high fidelity domain 212 as a temporary copy 214-3. When this occurs, it may be appreciated that the versions 214-2, 214-3 then share common ancestor in version 214-1, which then allows the versions 214-2, 214-3 to be merged together, resulting in a new high fidelity version 214-4, that contains the changes to both the low fidelity version 204-2 and the high fidelity version 214-2. The merge module 106c can then perform a straight import of the version 214-4 into the low fidelity version 204-3, where both of the versions 204-3, 214-4 are in synchronization and contain the changes in both of the versions 204-2, 214-2.

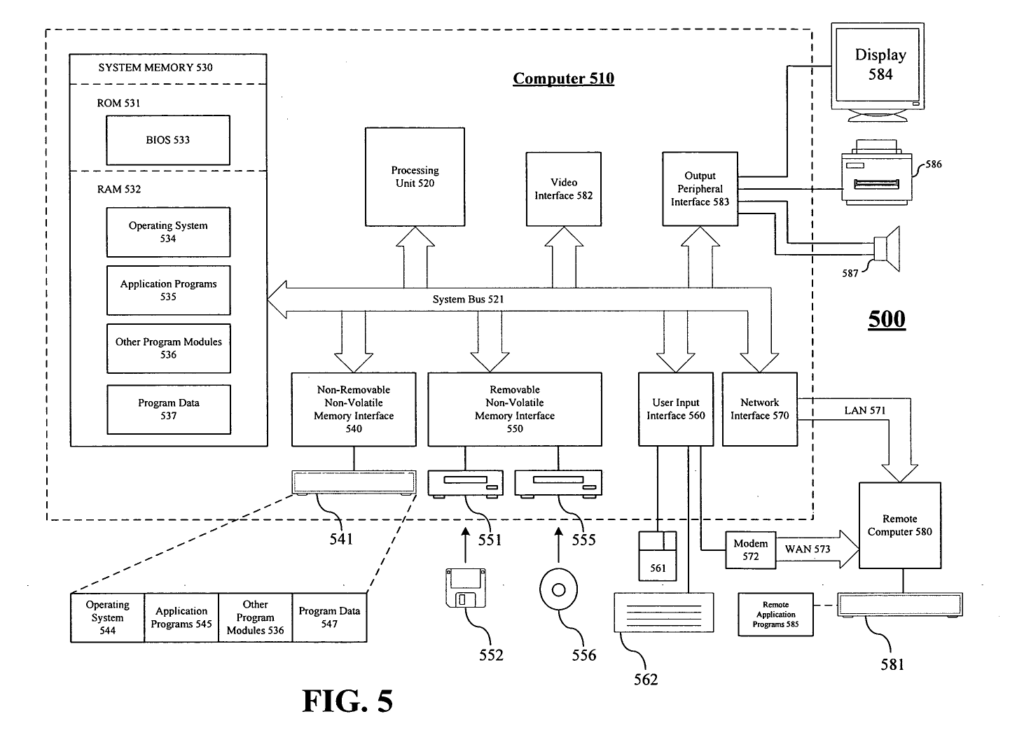

FIG. 5 illustrates a block diagram of a computing system architecture 500 suitable for implementing various embodiments, including the computing system 100. It may be appreciated that the computing system architecture 500 is only one example of a suitable computing environment and is not intended to suggest any limitation as to the scope of use or functionality of the embodiments. Neither should the computing system architecture 500 be interpreted as having any dependency or requirement relating to any one or combination of components illustrated in the exemplary computing system architecture 500.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 5, the computing system architecture 500 includes a general purpose computing device such as a computer 510. The computer 510 may include various components typically found in a computer or processing system. Some illustrative components of computer 510 may include, but are not limited to, a processing unit 520 and a memory unit 530.

In one embodiment, for example, the computer 510 may include one or more processing units 520. A processing unit 520 may comprise any hardware element or software element arranged to process information or data. Some examples of the processing unit 520 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 520 may be implemented as a general purpose processor. Alternatively, the processing unit 520 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 510 may include one or more memory units 530 coupled to the processing unit 520. A memory unit 530 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 510. The embodiments are not limited in this context.

In one embodiment, for example, the computer 510 may include a system bus 521 that couples various system components including the memory unit 530 to the processing unit 520. A system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 510 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 500. Examples of computer readable media for computing system architecture 500 may include, but are not limited to, volatile and/or nonvolatile memory such as ROM 531 and RAM 532. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 530 includes computer storage media in the form of volatile and/or nonvolatile memory such as ROM 531 and RAM 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable, volatile/nonvolatile computer storage media. By way of example only, FIG. 5 illustrates a hard disk drive 540 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 584 or other type of display device is also connected to the system bus 521 via an interface, such as a video interface 582. In addition to the monitor 584, computers may also include other peripheral output devices such as speakers 587 and printer 586, which may be connected through an output peripheral interface 583.

The computer 510 may operate in a networked environment using logical connections to one or more remote computers, such as a remote computer 580. The remote computer 580 may be a personal computer (PC), a server, a router, a network PC, a peer device or other common network node, and typically includes many or all of the elements described above relative to the computer 510, although only a memory storage device 581 has been illustrated in FIG. 5 for clarity. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other technique suitable for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other techniques for establishing a communications link between the computers may be used. Further, the network connections may be implemented as wired or wireless connections. In the latter case, the computing system architecture 500 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Some or all of the computing system 100 and/or computing system architecture 500 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously described. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
importing a first low fidelity version of a document from a low fidelity domain to a high fidelity domain to form a first high fidelity version of the document;
modifying the first low fidelity version of the document to form a second low fidelity version of the document;
modifying the first high fidelity version of the document to form a second high fidelity version of the document; and
synchronizing the modifications between the second low fidelity version and the second high fidelity version of the document using a three-way merge.

2. The method of claim 1, comprising:
importing the second low fidelity version from the low fidelity domain to the high fidelity domain to form a third high fidelity version of the document; and
performing the three-way merge with the first high fidelity version, the second high fidelity version, and the third high fidelity version of the document to form a fourth high fidelity version of the document.

3. The method of claim 2, comprising performing the three-way merge to form the fourth high fidelity version of the document having modifications from both the second high fidelity version and the third high fidelity version.

4. The method of claim 2, comprising exporting the fourth high fidelity version from the high fidelity domain to the low fidelity domain to form a third low fidelity version of the document.

5. The method of claim 2, comprising exporting the fourth high fidelity version from the high fidelity domain to the low fidelity domain to form a third low fidelity version of the document having modifications from both the second high fidelity version and the third high fidelity version.

6. The method of claim 1, comprising modifying the first high fidelity version of the document to include content that cannot be represented in the low fidelity domain to form the second high fidelity version of the document.

7. The method of claim 1, comprising modifying the first high fidelity version of the document to include content that can be represented only in the high fidelity domain to form the second high fidelity version of the document.

8. An article comprising a storage medium containing instructions that if executed enable a system to:
import a first low fidelity version of a document from a low fidelity domain to a high fidelity domain to form a first high fidelity version of the document;
modify the first low fidelity version of the document to form a second low fidelity version of the document;
modify the first high fidelity version of the document to form a second high fidelity version of the document;
import the second low fidelity version from the low fidelity domain to the high fidelity domain to form a third high fidelity version of the document; and
perform a three-way merge with the first high fidelity version, the second high fidelity version, and the third high fidelity version of the document to form a fourth high fidelity version of the document.

9. The article of claim 8, further comprising instructions that if executed enable the system to perform the three-way merge to form the fourth high fidelity version of the document having modifications from both the second high fidelity version and the third high fidelity version.

10. The article of claim 8, further comprising instructions that if executed enable the system to export the fourth high fidelity version from the high fidelity domain to the low fidelity domain to form a third low fidelity version of the document.

11. The article of claim 8, further comprising instructions that if executed enable the system to export the fourth high fidelity version from the high fidelity domain to the low fidelity domain to form a third low fidelity version of the document having modifications from both the second high fidelity version and the third high fidelity version.

12. The article of claim 8, further comprising instructions that if executed enable the system to modify the first high fidelity version of the document to include content that cannot be represented in the low fidelity domain to form the second high fidelity version of the document.

13. The article of claim 8, further comprising instructions that if executed enable the system to modify the first high fidelity version of the document to include content that can be represented only in the high fidelity domain to form the second high fidelity version of the document.

14. The article of claim 8, further comprising instructions that if executed enable the system to

15. A computer system, comprising:
a first application program having a low fidelity domain; and
a second application program having a high fidelity domain, the second application program having a fidelity synchronization module to synchronize modifications between a low fidelity version of a document made using the first application program and a high fidelity version of the document made using the second application program using a three-way merge.

16. The computer system of claim 15, comprising:
an import module to import a first low fidelity version of the document to form a first high fidelity version of the document;
the first application program arranged to modify the first low fidelity version of the document to form a second low fidelity version of the document;
the second application program arranged to modify the first high fidelity version of the document to form a second high fidelity version of the document; and
the import module to import the second low fidelity version to form a third high fidelity version of the document; and
a merge module to perform the three-way merge with the first high fidelity version, the second high fidelity version, and the third high fidelity version of the document to form a fourth high fidelity version of the document.

17. The computer system of claim 16, the merge module to perform the three-way merge to form the fourth high fidelity version of the document having modifications from both the second high fidelity version and the third high fidelity version.

18. The computer system of claim 16, comprising an export module to export the fourth high fidelity version from the high fidelity domain to the low fidelity domain to form a third low fidelity version of the document.

19. The computer system of claim 16, comprising an export module to export the fourth high fidelity version from the high fidelity domain to the low fidelity domain to form a third low fidelity version of the document having modifications from both the second high fidelity version and the third high fidelity version.

20. The computer system of claim 16, the second application program to modify the first high fidelity version of the document to form the second high fidelity version of the document, the modification to include content that cannot be represented in the low fidelity domain of the first application program.
